(19) United States
(12) Patent Application Publication
(10) Pub. No.: US 2007/0250927 A1
(43) Pub. Date: Oct. 25, 2007

(54) Application protection

(75) Inventors: Dilip Naik, Redmond, WA (US); Chandan Kudige, Caroline Springs (AU)

Correspondence Address: PERKINS COIE LLP;PATENT-SEA, P.O. BOX 1247, SEATTLE, WA, 98111-1247, US

(73) Assignee: Wintutis, Inc., Redmond, WA (US)

(21) Appl. No.: 11/409,124

(22) Filed: Apr. 21, 2006

(51) Int. Cl. G06F 12/14

(52) U.S. Cl. 726/22

(57) ABSTRACT

A facility is described for preventing an application from becoming infected with malicious code. In various embodiments, the facility starts an application in debug mode, intercepts an application program interface method that loads code, receives an indication that the application program interface method was invoked to load a component, determines whether the component is a trusted component, and, when the component is not trusted, prevents the component from being loaded.

### BACKGROUND

Personal computer systems play an increasingly important role in electronic commerce, such as in online shopping, bill paying, banking, stock trading, and so forth. Malicious software that exploits bugs or vulnerabilities in the software running on computers is also becoming increasingly prevalent. The time between announcement of a software bug or vulnerability and availability of malicious software to exploit that bug has been decreasing. Malicious software injects itself or other malicious code into the memory of running computer systems by taking advantage of these bugs or vulnerabilities. Once it is present in memory, the malicious software or code downloads a larger amount of malicious code, such as via the Internet.

Commercial software vendors have used terms such as “virus,” “worm,” “Trojan horse,” and “spyware” to describe malicious code. Other types of malicious code also exist, collectively referred to as “malware.” Malware has moved from the domain of hackers, who did it purely for fun or challenge, to the domain of nefarious people who attempt to gain financially or otherwise by creating or using malware. Moreover, extremely targeted malware has appeared that simply waits for a user to log into a bank account and then simply transfers money by hijacking the session created by the logged-in user. Thus, simply being vigilant by protecting passwords may be insufficient to combat such malware.

A number of solutions have been developed in an attempt to counter the threat of malware. The attempted solutions include virus or spyware scanners, behavior detectors, sandboxes, firewalls, and so forth. These attempted solutions appear reasonable but have various deficiencies.

Virus scanners and spyware scanners attempt to identify and remove malware using known characteristics of the malware. These known characteristics are generally contained in a signature file. A problem with this solution is that the virus scanner is only as good as the information about the malware contained in the signature file. This implies that somebody somewhere will be infected with the malware before the vendor of the virus scanner acquires sufficient details about the malware to be able to reliably detect it and update the signature file to enable the virus scanner software to remove or destroy the virus. Another problem is that even after the vendor has updated the signature file, the virus scanner software is potentially useless until the signature file on the infected computer system is updated. In some cases, whether the virus scanner is successful also depends on whether the signature file gets updated first or the malware gets on the computer system first. This occurs because some malware disables the security software (e.g., virus scanner software) or prevents the security software from accessing websites to update its signature file. Some forms of malware are extremely difficult to detect using this signature-based technique.

Other non-technical problems arise when using some anti-spyware products. As an example, when a spouse installs a commercial keystroke logging (“keylogger”) software package, the other spouse may consider it to be spyware even though it was purposefully installed. The software vendor who sold the package claims to be selling a legitimate commercial product, and so it may not be identified as spyware by anti-spyware products. Consequently, a malware writer can simply exploit a bug to install a commercially available keylogger that may not be identified by anti-spyware products.

Enterprises have deployed behavior detectors that attempt to detect malware using rules that describe various behavioral characteristics. While these behavior detectors may sometimes work, they are very costly to operate because the rules are determined after considerable testing and need to be continuously updated as the enterprise behavior changes when new applications are deployed, existing applications are updated, or existing applications are used differently. Aside from the problem of cost, these behavior detectors also suffer from the fact that they sometimes identify legitimate software as malware or fail to identify genuine malware. Furthermore, even when code is identified as malware, the identification can be so late that considerable effort is needed to identify and undo the damage that was done by the malware prior to its detection.

Another technique that has been proposed and implemented to solve some related problems is known as “sandboxing.” A virtual software construct called a sandbox is implemented and suspect code is executed within the sandbox. The suspect code is carefully monitored when it tries to access resources outside the sandbox and affect the computer system, such as when it tries to modify files. This activity may be disallowed. A problem with this solution is that it only applies to code that is readily identifiable as needing to be in the sandbox. Malware exploits bugs in operating systems and applications, and installs itself onto a computer system in such a way that it is not readily identifiable as code that was downloaded. Consequently, it is also not always identifiable as code that needs to be executed within a sandbox.

Malware can also be downloaded onto a computer system by luring the computer user into an action that results in the download of the malware, such as by opening a file that is attached to an electronic mail (“email”) message. Irrespective of how the malware got installed, the malware is no longer readily identifiable as needing to be within a sandbox.

Some techniques, such as the firewall software that ships with MICROSOFT WINDOWS XP®, have application programming interfaces and user interfaces to adjust their behavior. These techniques attempt to keep malware out of the system, but are not completely successful. Malware sometimes uses the interfaces provided by these techniques to defeat these techniques.

### BRIEF DESCRIPTION OF THE DRAWINGS

FIG. 1 is a block diagram illustrating a conventional computer system.

FIG. 2 is a block diagram illustrating a computer system with a secure safebox in some embodiments.

FIG. 3 is a block diagram illustrating a secure safebox and depicting the execution filter component, which acts as a filter for any code needed to execute within the secure safebox, in some embodiments.

FIG. 4 is a flow diagram illustrating operation of an execution filter component in some embodiments.

FIG. 5 is an operational diagram illustrating a method for hooking and filtering dynamically loaded code in some embodiments.

FIG. 6 is a block diagram illustrating an API interception mechanism associated with the facility in some embodiments.

### DETAILED DESCRIPTION

A facility is described for creating a secure safebox within which a pure, untainted, unadulterated application may execute. A safebox is a secure software construct that ensures that only known good code may enter the safebox and execute within it. The facility provides a secure safebox within which a pure and unadulterated version of an application can execute within a computer system, even when the computer system has been infected with malware or malicious code that attempts to inject itself into the running application, thereby adulterating it. In various embodiments, the secure safebox loads applications as a debugged process, intercepts method calls that load additional code, such as dynamically linked libraries, and only loads the additional code when various filtering rules are satisfied. The facility thus needs no a priori knowledge of the malware. Anybody engaged in activities that require security and privacy, such as electronic commerce (“ecommerce”), secure online banking, financial transactions, and running programs on computer systems that have stored trade secrets, will benefit from employing the facility as it ensures that the malware will not run within the secure application or operating system.

The facility enables an application to safely execute without being influenced by the presence of malicious code that may be residing on a computer system's hard disk or actively executing within the memory of the computer system. The facility enables an application, such as a web browser, to be used without fear of contamination by malware that intercepts key strokes, steals passwords, or produces other undesirable behavior. In some embodiments, the facility enables applications to execute without enabling malware to execute within the context of the application, and thereby prevents malware from performing malicious actions such as recording passwords by recording keystrokes, hijacking the application session, etc.

In some embodiments, the facility does not require user input or decisions relating to whether or not some software is malware. In some embodiments, the facility does not provide application program interfaces or user interfaces that malware can misuse.

A safebox is analogous to a playpen that is used to keep a toddler safe and occupied. The entity to be protected, e.g., the toddler, is placed in the playpen and all objects that may be malicious, such as knives, scissors, etc., are kept outside. In the case of a safebox, the knives and scissors are the malicious code that attempt to enter the safebox. A “protected application” is loaded into a safebox and the malicious code is kept outside the safebox. The safebox ensures that no unknown code is allowed to execute. By comparison, a sandbox ensures that downloaded code executes within the sandbox and limits what the downloaded code may do outside the sandbox.

In some embodiments, the facility attempts to ensure that only specified code can enter the safebox. In contrast, conventional sandboxes allow any code to enter the sandbox, but focus upon limiting what the code is allowed to do once that code has entered the sandbox.

The facility enables privacy protection, secure ecommerce applications, security for applications such as personal tax programs, personal banking or email programs, etc.

Modern computer systems and applications generally have published interfaces that allow for the functionality of an application to be extended. To provide a specific example, a web browser such as Internet Explorer enables functionality to be extended using browser-provided functionality, such as using MICROSOFT ACTIVE-X controls. The functionality of a web browser may also be affected by computer operating system extensions, such as a dynamic link library (“DLL”) that is automatically loaded. Modern computer operating systems (“OS”) also allow for a privileged process to access all physical memory including memory belonging to a different process. Malicious code can take advantage of these OS features to inject code, such as key loggers or spyware, into the executing application's process. The facility provides mechanisms to defeat such methods of affecting the application and ensures that the application within the safebox is secure from interference by code outside the safebox.

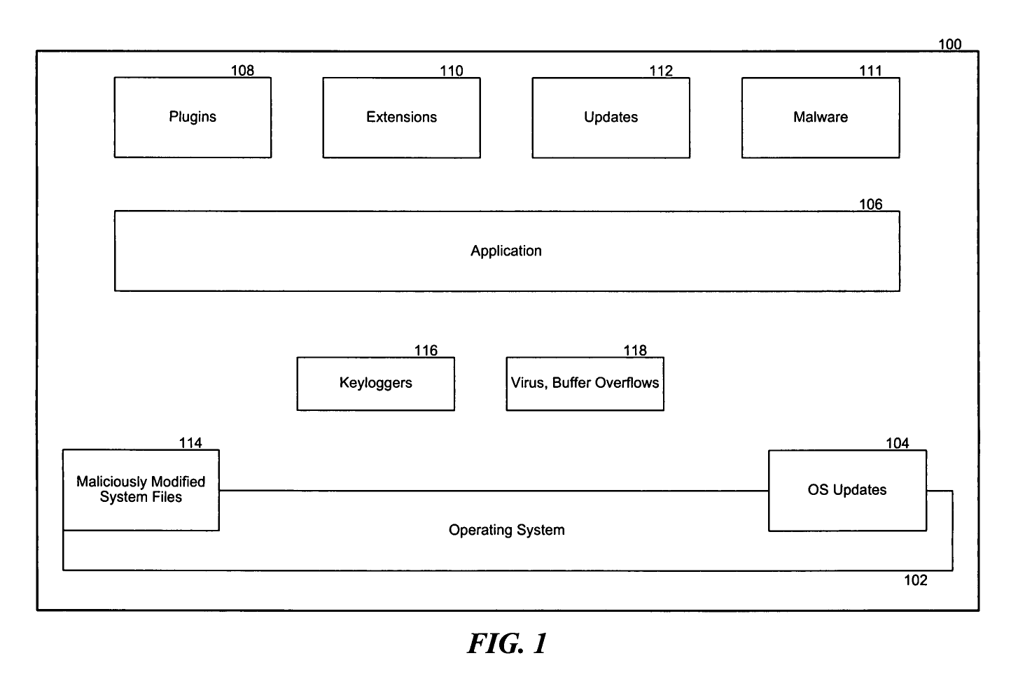

The facility provides a method of creating a secure safebox within which only a “pristine” version of any software application is allowed to execute. A pristine version of an application is a version that was originally installed without interference by malware. FIG. 1 is a block diagram illustrating a typical computer system 100, which has multiple “original system files” and “original application files.” The original system files and original application files are the files that were installed on the computer when the computer system was first installed, such as operating system files 102, operating system updates 104, application files 106, application plugins 108, application extensions 110, and application updates 112. The operating system can be MICROSOFT WINDOWS, a variant of UNIX (e.g., LINUX), APPLE MAC-OS, etc. In addition, FIG. 1 also illustrates multiple “potentially malicious files,” which are everything that was copied onto the system after the original OS or applications were installed. Malware may also be present, such as maliciously modified system files 114, keyloggers 116, viruses and various components 118 that take advantage of buffer overflow bugs, and malware 111. Potentially malicious files include additional software downloaded from the Internet, plugins, extension components, viruses, Trojan horses, spyware, malware, adware, etc. Some of these files are downloaded by the user and others are installed by malicious code that exploits security vulnerabilities of the computer system. Some of these files could be potentially dangerous to the computer system and, if the user engages in critical activities such as logging into the user's online banking system or creating online travel reservations using their credit card number, these activities could be monitored and the password, credit card numbers, or other sensitive information could be stolen by the malicious code and recorded or transmitted to another computer system.

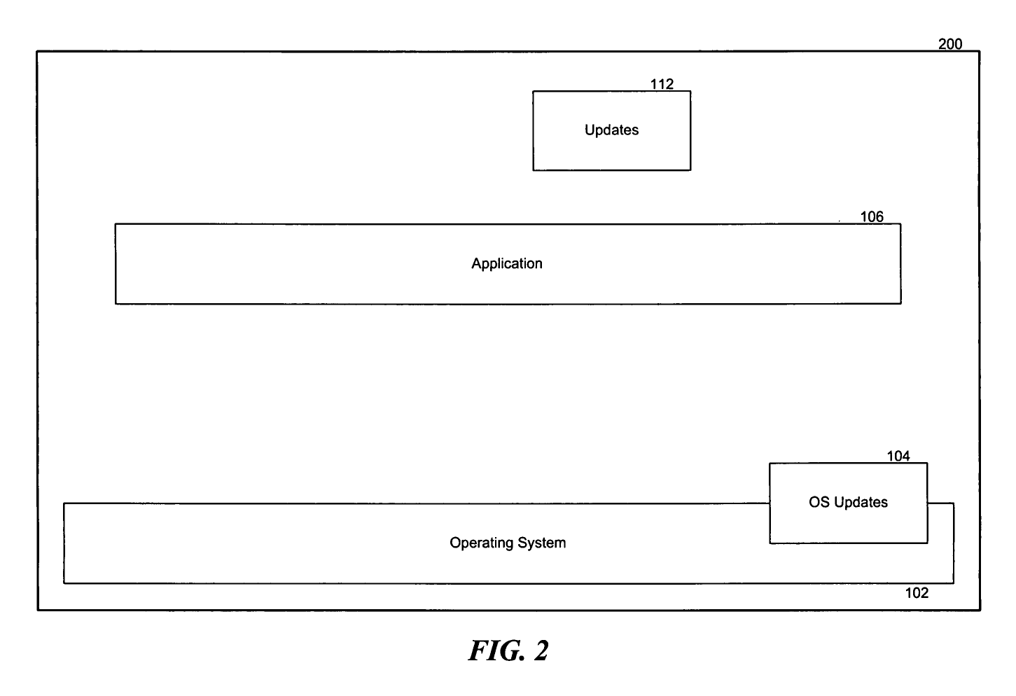

FIG. 2 is a block diagram illustrating the computer system of FIG. 1 with a safebox 200. The safebox disallows all potentially malicious code from executing, including all plugins, extensions, malware, maliciously modified system files, keyloggers, viruses, etc., and allows only original system and application files to execute.

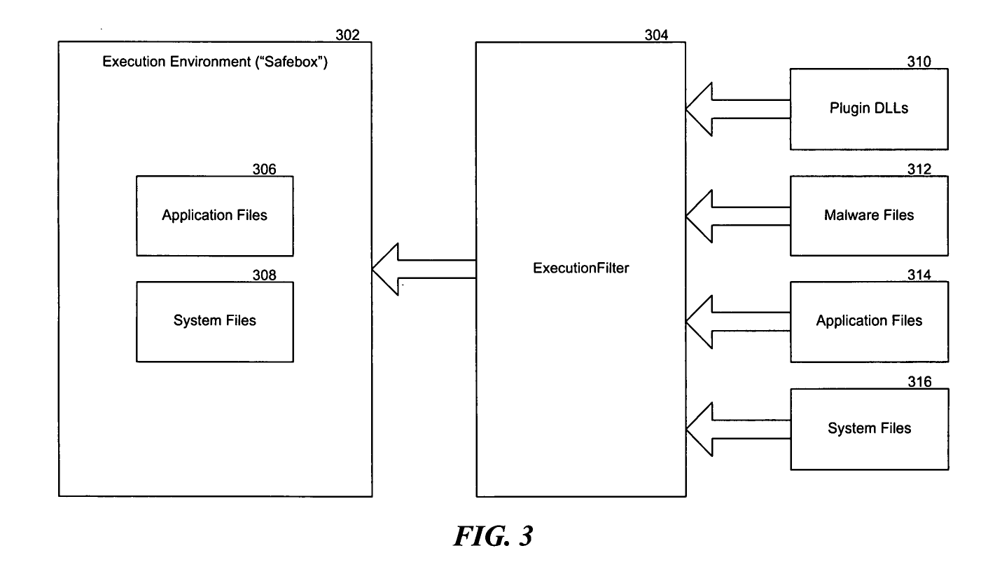

FIG. 3 is a block diagram illustrating components of the facility in various embodiments. The components include an execution environment 302 and an execution filter 304. The execution environment (e.g., a safebox) includes application files 306 and system files 308. The execution filter intercepts all attempts to load code into the safebox and then determines which code should be allowed into the safebox and which code should not be allowed. As examples, plugin code 310 and malware files 312 are not allowed into the safebox. However, application files 314 and system files 316 are allowed into the safebox (e.g., as application files 306 and system files 308).

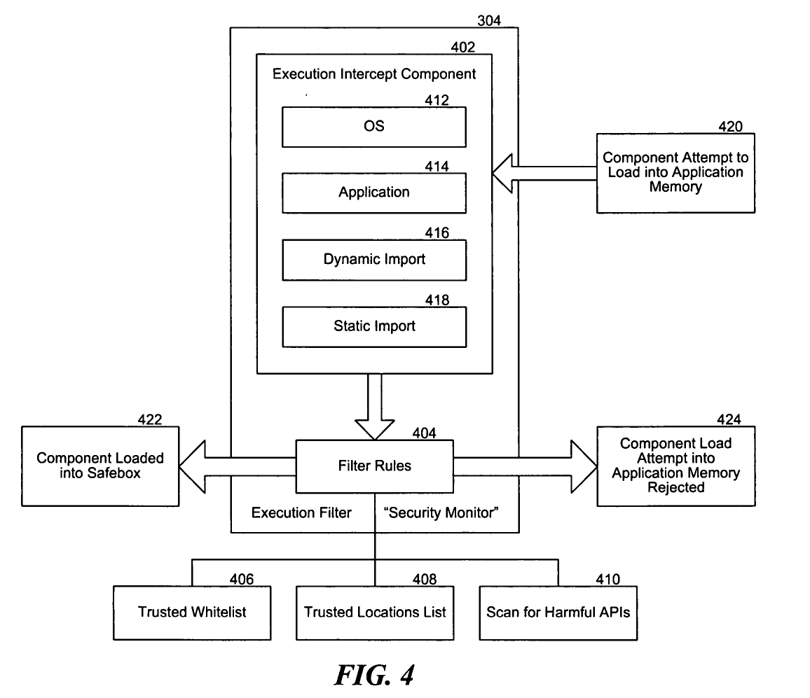

FIG. 4 is a flow diagram illustrating a mechanism used by the execution filter to decide which code is to be allowed into the safebox and which code should be disallowed. The execution environment 302 is constructed such that all attempts to bypass the execution filter 304 and directly inject code into the execution environment are prevented. This is accomplished by running the execution environment as a process that is being debugged. When a process is executed in such a manner, another process, such as the execution filter, can control the debugged process.

To create a safebox or execution environment, the facility creates a privileged process called the security monitor process. The security monitor process in turn creates a process that executes a protected application. This newly created process that the security monitor creates is the safebox or execution filter and is provided debug privileges to only the security monitor process. As a result, other processes are prevented from directly accessing the memory of the protected application.

Several safeboxes can execute simultaneously on a computer system. Each safebox comprises an application being executed in an execution environment that is launched by a security monitor. Additionally, each safebox also handles child processes of the protected application, as and when the child processes are created. The security monitor is analogous to an application loader that executes the “main” application file when an application loads.

Most operating systems provide debugging application program interfaces (APIs). In a MICROSOFT WINDOWS operating system, the security monitor provides the full path of the application's executable file to the CreateProcess( ) API along with the option DEBUG_ONLY_THIS_PROCESS. This enables the security monitor to execute the application in a controlled manner and receive notifications for debug-related events, such as threads being created and destroyed, components being loaded and unloaded, exceptions being generated, etc.

The execution filter component is illustrated in FIG. 4. It comprises an execution intercept component 402 and filter rules component 404. The execution intercept component hooks into various execution paths in which a new component can be loaded into application memory. As an example, the execution intercept component intercepts components loaded by the operating system (OS) using APIs LoadImageNotify, CreateProcessNotify, and CreateThreadNotify. The execution intercept component can be implemented as a kernel-mode driver. At the application level, the execution intercept component intercepts load events using debug APIs. The execution intercept component hooks into the component import address table (IAT) for tracking statically imported components, and it hooks into dynamic loading APIs (such as dl_open, LoadLibrary, etc.) to intercept dynamically loaded components. These hooks are described in further detail below.

The filter rules component provides methods for filtering code. A trusted whitelist 406 contains a list of files and their checksums as of the time the operating system was first installed. A trusted locations list 408 provides a list of all file system paths that contain system data and not other information, and hence are considered part of the original or pristine environment. An alternate mechanism involves scanning 410 the import list of each component being loaded for a list of harmful and disallowed APIs and deny loading the component if a harmful API is discovered.

The execution intercept component provides methods that employ various APIs, such as OS 412, application 414, dynamic import 416, and static import 418, to intercept attempts by components to load code.

When a component attempts to load code (e.g., another component, DLL, etc.) into application memory 420, the filter rules component 404 invokes methods or searches checklists to determine whether the code or component should be loaded into the safebox 422 or the attempt should be rejected 424.

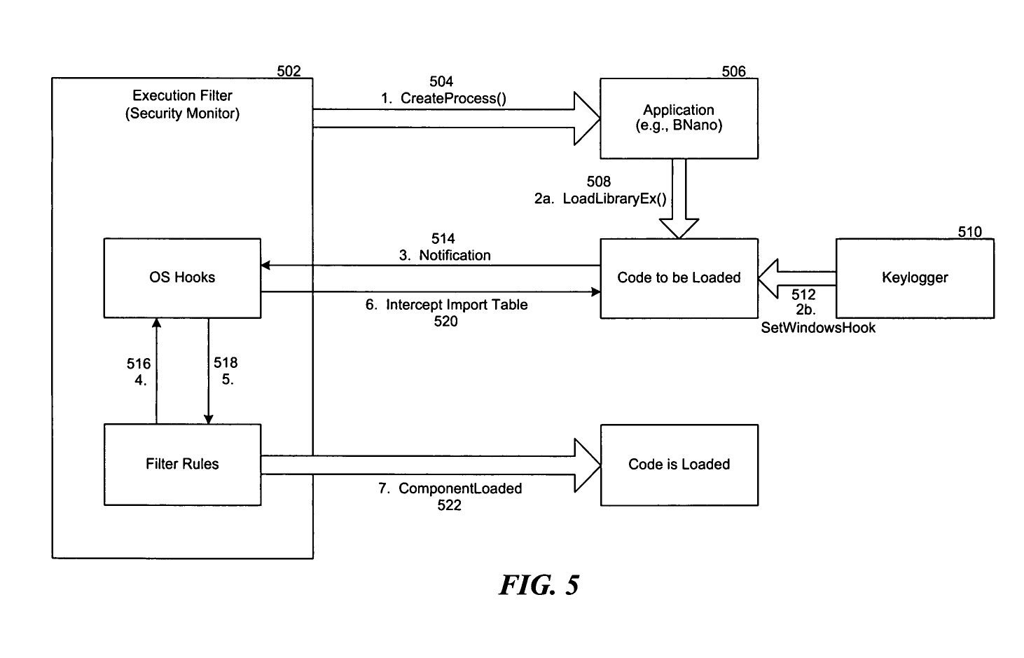

FIG. 5 is an operational diagram illustrating a method for hooking and filtering dynamically loaded code. The method creates a safebox for an application and loads a component into the created safebox after ensuring that the component does not contain potentially malicious code.

In this example, Internet Explorer is the application that is to be executed within the safebox to be protected, and shall be referred to as “BNano,” as opposed to an unprotected Internet Explorer.

In general, the safebox may be implemented in at least three different ways: (1) by developing components that run in the OS's user mode as well as another component that runs in the OS's kernel mode; (2) by developing components that run purely in the OS's user mode; and (3) by developing components that run purely in the OS's kernel mode.

User Mode and Kernel Mode Components

In various embodiments, the facility can be implemented with components having code that executes in both the OS's user mode and kernel mode. In these embodiments, a user starts execution of BNano by selecting (e.g., double-clicking) a special icon associated with this application. This action launches the safebox's security monitor process 502, which in turn starts the original Internet Explorer (the protected application 506) using the CreateProcess( ) API method 504 and passes the option DEBUG_ONLY_THIS_PROCESS to this API method.

The security monitor then waits until the protected application is completely loaded so that API methods that can be used to load new code can be properly intercepted by the security monitor. The security monitor uses the API method LoadImageNotification( ) to detect whether the protected application has completely loaded. When the protected application has completely loaded, the kernel mode driver is notified by the operating system via a LoadImageNotification( ) API method 514. This occurs because the kernel mode driver has previously registered a callback method with this API.

Once the security monitor has detected that the protected application has been completely loaded, it intercepts relevant APIs that can be used to load new code by intercepting relevant APIs in each component. The routines used to intercept the APIs are described in further detail below.

Internet Explorer may attempt to load browser extension code using the LoadLibraryEx( ) API method 508. This API is intercepted by the execution intercept component using an API interception routine described in further detail below. As a result, control is passed to the execution filter, which evaluates the filter rules to determine whether the code Internet Explorer is attempting to load is to be loaded. If the code is to be loaded, then control is returned to the original LoadLibraryEx( ), which continues to load the code. If the code is not to be loaded, control returns to Internet Explorer with an error code.

An external process (e.g., keylogger 510) may attempt to inject code by invoking SetWindowsHookEx( ) API method 512. When this method is invoked, the operating system attempts to load the code within the BNano process context, hence triggering the LoadLibraryEx( ) method, which causes the same control flow as described above in relation to LoadLibraryEx( ) 508.

When the code is successfully loaded into the application memory by the OS, a LoadImageNotify routine is triggered in the kernel mode driver. The LoadImageNotify routine accesses the newly loaded image in the memory and scans the import table for static library imports and all imported APIs. This information is stored in a data structure called InterceptInfo within the application's process context. After returning from the LoadImageNotify routine, the OS initializes the loaded code, which includes binding all the imported libraries and APIs.

When the code is successfully initialized and the import list processed, the OS triggers a debug event at the application level. This event is intercepted 516 by the security monitor, which in turn triggers the kernel driver once again to inform the kernel driver to override the import address table and intercept all the APIs. This procedure is described in further detail below. The security monitory may also evaluate 518 filter rules to determine which code loading is to be allowed or disallowed.

The kernel driver queues an asynchronous procedure call (“APC”) within the Internet Explorer process context. This APC processes 520 the InterceptInfo data and overwrites the IAT with pointers to a newly allocated memory segment indicating API stubs for each API being intercepted. These API stubs in turn intercept other components being loaded by the loaded code. The IAT is described in further detail below. Allowed code may then be loaded 522.

Routines for Intercepting APIs

The routines for intercepting APIs can intercept code-loading APIs invoked by statically linked code or dynamically linked code. One way of ensuring that undesired code does not enter the safebox is to intercept all ways an OS has for loading executable code. Since a typical OS may provide multiple ways (e.g., APIs) for loading executable code, all these multiple APIs may need to be intercepted. Accordingly, the following description provides details as to how to intercept or hook any given API. The same technique may then be employed for multiple APIs, as required by the OS.

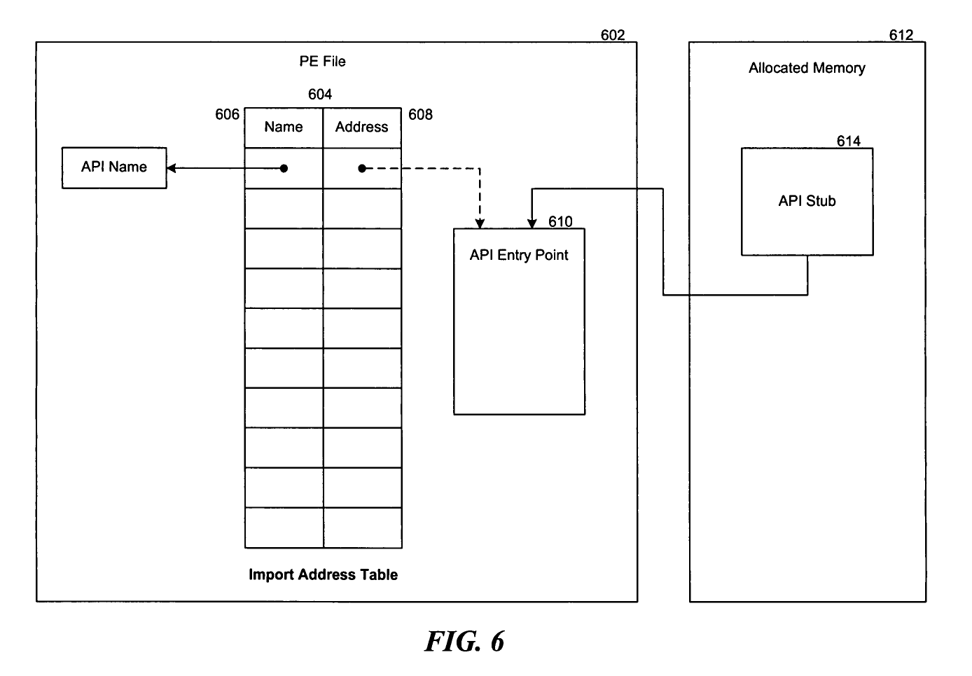

FIG. 6 illustrates a conceptual overview of the techniques involved in the API interception mechanism. Windows executable files have a fairly well documented file format called Portable Executable (PE) file format 602. The PE file format specifies an IAT 604. The IAT contains an entry directory section that points to an import table for each statically imported component. Each entry in the IAT corresponds to a single API that is imported from the import component and, among other things, points to the name of the API 606 being imported and the address 608 in the memory location where the imported function can be found. The memory location is identified by the loader once the import components have been successfully loaded. When the application code invokes one of the imported APIs, the address corresponding to the function pointer 610 in the IAT entry will be invoked.

The facility allocates a new section of memory (“intercept section”) 612 when the code is loaded and waits for the loader to load the imported code and update the IAT table, and then modifies the table to change the function pointers to locations within the intercept section. The intercept section is populated with code for each API (“API stub”) 614, which is created as follows. The following is a description of the API stub. Further details relating to waiting for the loader to load code are provided below.

PUSH <original API address>
PUSH EAX
PUSH <pointer to DLL name>
PUSH <pointer to API Name>
PUSH <api index>
Int 0x23 ; trap the api call
Pop eax ;api_index
Pop eax ;apiname
Pop eax ;dllname
Pop eax; saved eax
Ret ; Call the original API
Push 0xffffffff ; indicates function return
Push eax ; return value
Push <dllname>
Push <apiname>
Push <api index>
Int 0x23 ; trap the function return
Pop eax ;api_index
Pop eax ;apiname
Pop eax ;dllname
Pop eax; saved eax
Ret; Return to the original caller

Dynamic APIs are APIs that are imported by the calling component dynamically, such as by using the API method GetProcAddress( ). As is described above, GetProcAddress( ) is intercepted via static API interception. Consequently, when the application attempts to import a dynamic symbol, it passes control to interrupt 0×23 interrupt handler during the call to GetProcAddress( ).

When the GetProcAddress( ) call is interrupted by the kernel-mode driver, the interrupt handler checks whether the symbol is already imported. If so, it simply returns the previous value for this symbol. If not, the interrupt handler allocates a new API stub for the symbol, fills in the apiname, api_index, and dllname fields in the structure and passes the control to the original GetProcAddress( ).

When the GetProcAddress( ) call returns, the interrupt handler checks whether the return value is non-zero, and, if so, fills in all the other fields in the previously allocated API stub and returns the pointer to the API stub instead of the function pointer.

Accordingly, calls to the newly imported symbol would be intercepted by the API stub before control is transferred to the original function.

The following describes a routine for intercepting dynamic APIs that are imported by a process (“process X”). The method intercepts the symbol “GetProcAddress” for process X. The intercept routine for GetProcAddress checks the symbol that is being intercepted. If the symbol is listed in a list of symbols associated with API methods that can load code, then after the GetProcAddress method returns, the routine allocates a new API stub for this symbol and initializes it as described above. The routine then updates the API stub with the return value of GetProcAddress, and returns the API stub. When a calling component or code invokes the newly imported symbol, the API stub is called instead, which passes control to the intercept routine. This process is repeated for each dynamic symbol imported by the process X.

Application extensions, such as Internet Explorer plugins or operating system-defined extension capabilities, will generally load an executable file. This is generally true for all operating systems. As an example, on MICROSOFT WINDOWS, this results in the loading of a DLL file, but in some circumstances such as keyboard-hooking malware, the loaded file may be an “exe” file rather than a “DLL” file. The facility intercepts the loading of all such executable files within the safebox.

MICROSOFT WINDOWS provides several API methods to load executable code, all of which are intercepted by the facility in various embodiments.

LoadLibraryA is intercepted and replaced by InterceptedLoadLibraryA; LoadLibraryW is intercepted and replaced by InterceptedLoadLibraryW; LoadLibraryExA is intercepted and replaced by InterceptedLoadLibraryExA; and LoadLibraryExW is intercepted and replaced by InterceptedLoadLibraryExW. The methods for intercepting the API methods are described above. The interception APIs are referred to as InterceptXXX.

The InterceptXXX routine obtains the path of the DLL that is to be loaded and determines whether the path belongs to a whitelist. A whitelist indicates DLLs that are safe for loading. In some embodiments, the InterceptXXX routine checks whether the path belongs to a safe directory list that lists folders that contain safe DLLs. In some embodiments, the InterceptXXX routine scans DLLs to determine whether they import or invoke any unsafe APIs.

The InterceptXXX function also verifies checksum for the DLL to be loaded, if the checksum is available. If these checks or verifications are successful, the routine enables the DLL to be loaded by invoking the original API. If these checks or verifications are unsuccessful, the routine returns an ACCESS_DENIED error without invoking the original API. If the DLL was denied loading, the routine updates a logfile or displays a message to the user.

In some embodiments, the facility employs components that execute in a user mode of the operating system. In MICROSOFT WINDOWS, the facility employs a file system filter driver. The file system filter loads and enumerates mounted volumes and attaches to them. It then retrieves the identifier of the safebox process(es), such as by noting the process id when the relevant executable file (e.g., BNano.exe) is opened for execution. The file system filter driver then registers for notifications of new volumes being mounted and attaches to those volumes upon being notified of the new volume being mounted.

When an attempt is made to load an executable component, the file system filter driver intercepts the request because it is attached to all volumes. In particular, the filter driver gets an IRP_MJ_CREATE I/O request interrupt with the file access type indicating the file is being opened for execution.

The file system filter driver then retrieves the identifier of the current executing process and determines whether this is the identifier of the safebox process or not. If the request is for a process other than a safebox, the request is simply chained on and no further processing by the safebox filter driver is needed.

If the request is for the safebox process, the file system filter driver applies a set of filtering rules to determine whether the file open should be allowed or not. If the file execution/load is to be permitted, the file system filter driver simply chains on the request and needs to do no further processing. If the file system filter driver determines that the file loading should not be allowed, it completes the I/O request with an ERROR_ACCESS_DENIED error return code.

The file system filter driver applies similar rules processing that are applied when the facility employs a mixed user and kernel mode components. The file system filter driver then verifies checksum for the DLL to be loaded, if the checksum is available.

In some embodiments, the facility provides a user interface that informs a user that an application is attempting to load a component (e.g., malware) and enables the user to command the facility to allow or disallow the loading of the component.

In some embodiments, the facility can be configured to prevent a user from using an unprotected application in some ways. As an example, a Web browser application such as Internet Explorer may be prevented from retrieving content from secure websites, providing information (e.g., credit card numbers) to a secure web site, and so forth.

In some embodiments, the facility can enumerate all content that is not trusted (e.g., potentially malicious code). As an example, the facility can enumerate all components, files, and so forth that were not present when an operating system or application was installed, are not located in a trusted locations list, do not appear in a trusted whitelist, invoke methods of APIs that are considered harmful, and so forth. The user can then easily remove such content that is not trusted without affecting the computer system's operation or performance.

Malware that Runs in any Process Context

Malware can execute in any process context and not just in the process context of an application that needs to be protected. It is highly desirable to ensure that malware is unable to collect important information, such as passwords that are typed using the keyboard. The facility ensures that malware running outside the protected application's context cannot collect these and other kinds of critical information.

Kernel mode drivers typically run in an arbitrary process context. Thus, kernel mode drivers may be usable to collect critical information about any application, including the protected application running inside the safebox. Since kernel mode drivers are logically arranged in multiple device chains, one can enumerate the number of drivers in each device chain and compare it to an expected number. For example, a typical laptop or desktop computer has three drivers in the keyboard processing device driver chain. This device chain may be enumerated using operating system provided API methods, such as IoGetTargetDeviceObject and IoGetLowerDeviceObject. If an unexpected number of drivers is found, the extra driver(s) may need extra examination. Notwithstanding this extra examination, the user may be warned of the suspicious code in the form of the extra driver's presence.

Some kernel mode drivers need not be in any specific device chain but may still be able to collect critical information, such as keystrokes. However, such drivers use API methods that are seldom, if ever, used by legitimate applications. Hence these drivers may be either altogether prevented from running or the underlying API methods they use can be disabled by the facility. Such kernel mode drivers can also be detected by simply enumerating all the various software components running within the address space of the protected application was launched in the safebox.

Critical information may be collected by malware running in user mode, such as in a separate process context. This malware may be identified if it is using an API method that is seldom used by legitimate applications. Such malware may also be identified using other means, such as white lists and expected process behavior.

Some operating systems, such as MICROSOFT WINDOWS, expose an API to user processes called a system call interface, which is implemented within the kernel of the operating system. Some of these APIs allow one process to obtain information related to another process, such as message queues, screen shots, keystrokes etc. These APIs are employed by applications such as computer based training, recording and playing back macros, surveillance, help desks, etc. However it is undesirable for a protected application to allow an unprotected (and potentially malicious) process to obtain such information belonging to the protected applications. Examples of such APIs on WINDOWS are SetWindowsHookEx, GetAsyncKeyState, GetCapture, etc., referred to herein as “information capturing APIs.”

In some embodiments, the facility can be configured to hook into one or more such information capturing APIs to ensure that no data relating to protected applications can be obtained by another process regardless of its credentials and privileges. This is implemented in MICROSOFT WINDOWS by hooking the system call API table known as KeServiceDescriptorTable and replacing the function pointer with a function pointer belonging to the facility. This replacement function pointer executes additional checks on the parameters of the APIs to ensure that the data belonging to the protected application is not passed back to any unprotected application. This includes such techniques as analyzing the user mode callback functions passed by the unprotected application, verifying the process context in which the critical information is generated, returning error to the user process when such information belongs to the protected application process context, and discarding such information and preventing it from reaching the unprotected process.

The facility includes a mechanism for ensuring that the trusted files and the files in the trusted folder can indeed be trusted and that these files are not infected either online or offline. In some embodiments, one or more checksums are calculated for each of the trusted files that need to be loaded by a protected application and the checksums are matched against a database of checksums. The database of checksums is calculated based on the original versions of the files when these files were originally installed on a pristine system via an installation media that is digitally verified to be authentic. The database of checksums can be digitally signed to ensure that the information is not tampered with, such as by malware. These checksums are calculated for known good files rather than, for example, signatures for malware files.

In some embodiments, the database of checksums can be updated by the facility from a central server containing checksums. The update can occur from time-to-time, such as periodically. This helps the user keep the database up to date and enables the user to execute trusted operating system updates, new applications, and new versions of existing applications.

In some embodiments, vendors of software components (e.g., applications) and operating systems can provide checksums for data files whenever they distribute a new or updated version of the data files. These checksums can be added to the central server containing checksums and can be made available to users.

In some embodiments, the facility can detect infections that affect components of the facility itself. Upon installation of the facility, checksums of all the files associated with the facility are calculated and stored in a private file, which is digitally signed to ensure that it cannot be tampered with. These checksums are used to provide varying levels of protection. In the simplest form checksums are verified when the facility starts up (or when the operating system restarts). If the private file containing the checksums is tampered or if any of the files associated with the facility has a checksum that does not match the corresponding checksum stored in the private file, an error is provided to the user that indicates that the facility has been compromised and so the computer system should not be used for accessing important services.

In some embodiments, the checksums are verified every time a service is accessed and an additional filter driver is incorporated to ensure that file system requests to modify a file that is part of the facility are rejected. This ensures that not only are infections to the facility detected, but also prevented during the operation of the facility.

In some embodiments, an additional provision for ensuring integrity of all the components comprising the facility is provided. The private file containing the checksums can be verified with a centralized server, which ensures that the digital signature used to sign the private file is not compromised. This would be a value added service that is suitable for mission critical applications.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. A method performed by a computer system for preventing an application from becoming infected with malicious code, comprising:
starting an application in a debug mode;
intercepting an application program interface method that loads code into an application program memory associated with the started application;
receiving an indication that the application program interface method was invoked to load a component;
determining whether the component is a trusted component; and
when the component is not trusted, preventing the component from being loaded.

2. The method of claim 1 wherein the component includes executable code.

3. The method of claim 1 wherein the component includes interpretable code.

4. The method of claim 1 further comprising loading the component when the component is trusted.

5. The method of claim 1 wherein the component is trusted when it appears in a list of trusted components.

6. The method of claim 1 wherein the component is trusted when it appears in a trusted location.

7. The method of claim 6 wherein the trusted location is a folder containing components.

8. The method of claim 1 wherein the application program interface method is invoked by a component loaded by the application.

9. The method of claim 1 wherein the application program interface method is invoked by a component that is unassociated with the application.

10. The method of claim 9 wherein the component that is unassociated with the application is an add-in.

11. The method of claim 1 wherein the application program interface method is invoked by the application.

12. The method of claim 1 wherein the computer system executes a MICROSOFT WINDOWS operating system.

13. The method of claim 1 wherein the computer system executes a UNIX-like operating system.

14. The method of claim 1 wherein the computer system executes an operating system for APPLE MACINTOSH computers.

15. The method of claim 1 further comprising removing components that are not trusted.

16. The method of claim 1 wherein the component is not trusted when the component invokes the application program interface method that loads code.

17. The method of claim 1 wherein the component is not trusted when the component was not originally installed with an operating system associated with the computer system.

18. The method of claim 1 wherein the component is not trusted when the component was not originally installed with the application.

19. A computer-readable medium having computer-executable instructions that, when executed, perform a method for application protection, the method comprising:
receiving an indication to invoke an application;
creating a security monitor that invokes the application in a debug mode and intercepts an application program interface method that loads code;
receiving a notification indicating that the application program interface method was invoked to load a component;
determining whether the component should be loaded; and
when the component should not be loaded, preventing the component from being loaded.

20. The computer-readable medium of claim 19 further comprising applying a filter rule to determine whether the component should be loaded.

21. A system for providing application protection, comprising:
an execution filter component that invokes an application in debug mode and intercepts invocations of an application program interface method that loads code into memory allocated for the application; and
a filter rules component that determines whether to prevent a component from being loaded by the application program interface method.

22. The system of claim 21 wherein the component is prevented from being loaded when it is not trusted.

23. The system of claim 21 further comprising a component that detects potentially malicious code in a process context other than a process context of the invoked application.

24. The system of claim 23 wherein the component that detects potentially malicious code disables the potentially malicious code.

25. The system of claim 23 wherein the potentially malicious code is detected by analyzing a driver chain.

26. The system of claim 23 wherein the potentially malicious code is detected by determining that a generally unused application programming interface method is being used.

27. The system of claim 23 wherein the component that detects potentially malicious code prevents information associated with the invoked application from being communicated to the potentially malicious code.
